(19) United States
(12) Patent Application Publication
(10) Pub. No.: US 2017/0043349 A1
(43) Pub. Date: Feb. 16, 2017

(54) GRINDING ROLLER COMPRISING INSERTS OF INCREASED MASSIVENESS

(71) Applicant: MAGOTTEAUX INTERNATIONAL S.A., Vaux-sous-Chèvremont (BE)

(72) Inventors: Norbert Guerard, Esneux (BE); Eric Lejeune, Virton (BE)

(21) Appl. No.: 15/305,899

(22) PCT Filed: Apr. 16, 2015
(86) PCT No.: PCT/EP2015/058222

§ 371 Date: Oct. 21, 2016

(30) Foreign Application Priority Data
Apr. 23, 2014 (BE) 2014/0287

(51) Int. Cl. B02C 15/00; B22D 19/06; B02C 4/30

(52) U.S. Cl. CPC B02C 15/005; B02C 4/305; B22D 19/06; B02C 2210/02

(57) ABSTRACT

The present invention relates to a grinding roller for vertical axis crushers, produced by foundry casting, said roller comprising inserts with a massiveness modulus V/S comprised between 3 and 5 cm, preferably between 3.2 and 4.5 cm, said inserts being embedded in a metal matrix consisting of ductile iron or steel.

### FIELD OF THE INVENTION

The present invention relates to grinding rollers produced by casting in the technical field of foundry. These rollers are used in vertical axis crushers for grinding various materials, including coal, cement raw meal, clinker or slag. The invention more particularly relates to grinding rollers comprising inserts with higher massiveness moduli than those of the state of the art, optionally reinforced with ceramic grain agglomerates which can be infiltrated during casting.

### STATE OF THE ART

Application EP 1 570 905 A1 discloses a grinding roller for a vertical axis crusher comprising inserts with a low massiveness modulus (<2.5). This document emphasizes the various problems encountered during operation with bimetal grinding rollers comprising hard inserts in cast iron with high chromium content, embedded in a metal matrix of ductile cast iron. In this document, the inserts are spaced relatively to each other. This space is filled with ductile cast iron during the casting of the grinding roller, which generates a tab blocking the inserts against each other. During operation, these tabs, which are not very wear-resistant, become recessed, forming grooves between the inserts, which widen gradually as one approaches the center of the grinding roller (see FIG. 3).

Document U.S. Pat. No. 5,238,046 has the same drawbacks. Indeed, each insert comprises on at least one of its longitudinal flanks protruding ribs so as to form a space between two juxtaposed inserts. During the working of the roller, a preferential wear of the ductile alloy comprised in the space is achieved, resulting in the formation of grooves between the inserts.

### DEFINITIONS

In the foundry industry, the massiveness modulus is measured by the ratio of the volume to the surface. It is denoted by V/S. This value, universally used in the foundry industry, is among others taken into account in the calculation of the feeding of the cast parts since, in order to obtain a sound part, the feeder should have a V/S ratio greater than that of the part to be cast.

The value of the modulus V/S depends on the selection of the adopted length unit.

The calculation may be illustrated by the simple example of a cube of side “a”.
In this case, the V/S=a³/(6 a²), that is a/6.
If the V/S is expressed in meters for a cube with a side of one meter: a/6 becomes ⅙=0.166 m.
If the V/S is expressed in centimeters: a/6 becomes 100/6=16.6 cm.
In the description of the present invention, the modulus V/S will always be expressed in centimeters.

### AIMS OF THE INVENTION

The aim of the present invention is to limit the drawbacks of the state of the art by reducing as much as possible the presence of grooves formed by the interstices between the inserts of a grinding roller. In order to reduce this number of grooves, the size and the massiveness modulus of these inserts have to be increased. With more massive inserts, the latent heat available during casting will therefore be higher and will allow easier infiltrations of thicker ceramic reinforcements which can be infiltrated. As a corollary, the invention therefore makes it possible to increase the thickness of the ceramic reinforcement of the insert. By improving the infiltration conditions of the reinforcement by the casting metal, it is possible to use thicker reinforcements which in turn improve the wear resistance of the assembly.

### FEATURES OF THE INVENTION

The present invention discloses a grinding roller for vertical axis crushers, produced by foundry casting, said roller comprising inserts with a massiveness modulus V/S comprised between 3 and 5 cm, preferably between 3.2 and 4.5 cm, said inserts being embedded in a metal matrix consisting of ductile cast iron or steel.

According to preferred embodiments, the invention comprises at least one or one combination of the following features:
the grinding roller comprises inserts with a massiveness modulus V/S comprised between 3.4 and 4 cm;
the inserts are positioned against each other, only leaving intermittent recesses between two inserts and making it possible, during casting, to generate a binding element of the bolt type improving the fixation of the insert in the metal matrix;
the binding element of the bolt type comprises undercuts;
the inserts are not placed parallel to the axis of rotation of said roller, but form an angle of less than 45° with this axis;
the inserts have a curvature along their longitudinal axis;
the inserts have an “S” shape along the longitudinal axis;
the insert comprises one or several ceramic reinforcements which can be infiltrated by the casting metal;
said reinforcement ceramic is selected from among alumina, zirconia, alumina-zirconia, metal nitrides, metal carbides and borides or mixtures thereof.

The present invention also discloses a vertical axis crusher comprising a grinding roller according to the invention.

### SHORT DESCRIPTION OF THE FIGURES

FIG. 1 illustrates, according to the state of the art, a section of a vertical crusher in operation comprising several grinding rollers.

FIG. 2a illustrates a three-dimensional view of a grinding roller according to the state of the art with inserts with a low massiveness modulus and spaces between the inserts.

FIG. 2b shows a three-dimensional view of an insert with a low massiveness modulus comprising spacing protrusions according to the state of the art.

FIG. 3 shows, by means of a sectional view, the space remaining between two adjacent inserts according to the state of the art and the possibility of forming increasingly wide grooves between the inserts as the grooves become deeper.

FIG. 4 illustrates a three-dimensional view of an insert with a low massiveness modulus with a ceramic reinforcement and comprising spacers according to the state of the art.

FIG. 5 shows the comparative curves of the number of inserts in the case of inserts according to the state of the art (V/S<2.8 cm, squares in the graph) and of inserts according to the invention (V/S>3 cm, rhombuses in the graph). The number of inserts is reduced in the grinding rollers according to the invention.

FIG. 6a shows a sectional view of two inserts according to the invention arranged side by side with spacing protrusions making it possible to maintain a minimum distance between two inserts. According to the invention, the number of grooves is limited by the increase in the massiveness of the insert.

FIG. 6b illustrates a three-dimensional view of the insert illustrated in FIG. 6a.

FIG. 7a shows a sectional view of two inserts with a ceramic reinforcement according to the invention placed against each other with an intermittent recess.

FIG. 7b illustrates a three-dimensional view of one of the two inserts in FIG. 7a where the intermittent recess may be viewed. This recess will allow, during casting, the formation of a binding element similar to a bolt with undercuts making it possible to improve the fixation of the insert in the metal matrix. The insert also shows the positioning of a ceramic reinforcement which can be infiltrated by the casting metal increasing the wear resistance.

FIGS. 8a and 8b illustrate the same embodiment of the invention as the one in FIGS. 7a and 7b, however with an insert curved in the direction of its longitudinal axis forming an <<S>>. This <<S-shaped>> alternative allows the groove between the inserts not to encounter, during grinding, the material to be ground frontally and according to an angle of less than 90°.

FIG. 9 illustrates the same roller as the one in FIG. 2a but with inserts with a higher massiveness modulus according to the invention.

FIG. 10a shows an insert according to the state of the art as used in a roller for an LM46/4 Loesche® crusher, the comparative test results of which are illustrated in Table 1. FIG. 10b illustrates a section along B-B.

FIGS. 11a and 12a show inserts according to the invention as used in a roller for an LM46/4 Loesche® crusher, the test results of which are also illustrated in Table 1. FIGS. 11b and 12b respectively illustrate sections along B-B.

FIG. 13a shows a three-dimensional view of an insert according to one of the preferred embodiments of the present invention. In FIG. 13b, two of these inserts are placed against each other only leaving an intermittent recess with a variable diameter along a radial direction on the grinding roller. The recess will allow, during casting, the formation of a binding element of the bolt type with undercuts. Here, the insert also comprises a ceramic reinforcement which can be infiltrated by the casting metal.

FIG. 14 illustrates a three-dimensional view of an alternative of an insert which may be used in the roller according to the invention, wherein the recess is located on the lateral face in the axial direction of the insert. This recess will make it possible, during casting, to generate a binding element in the axial direction of the grinding roller. A ceramic reinforcement which can be infiltrated by the casting metal is also present in this embodiment.

FIGS. 15 and 16 illustrate an embodiment of the invention wherein the inserts are not positioned parallel to the axis of rotation of the grinding roller, but form an angle of less than 45° with this axis. This type of arrangement has the advantage that the groove between the inserts is presented obliquely during grinding of the material to be ground, which deteriorates less the surface of the grinding roller and therefore extends the lifetime of the latter.

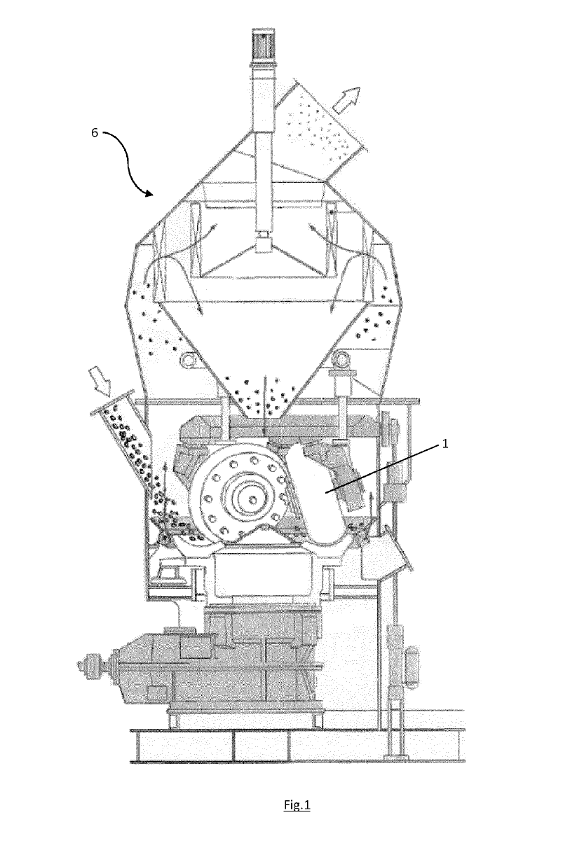

### CAPTION

1. Grinding roller.

2. Insert consisting of a composite or metal element that is highly wear-resistant, placed on the periphery of the grinding roller.

3. Recesses left between the inserts making it possible to generate a binding element made by the casting metal. The binding element will comprise a sort of <<bolt>> which may comprise undercuts.

4. The metal matrix formed by the casting metal consisting of cast iron or steel and making up the structure of the roller.

5. A ceramic reinforcement or a reinforcement made of an agglomerate of ceramic grains located in the insert, also called a <<cake>>, <<padding>> or <<wafer>>.

6. A vertical axis crusher which comprises the grinding roller; this is the wheel which crushes the material on the table of the crusher.

### DETAILED DESCRIPTION OF THE INVENTION

The grooves between the inserts 2 of a grinding roller 1 form a preferential wear location which is not only detrimental to the lifetime of the grinding roller 1, but also to the efficiency of the grinding and to the quality of the ground product. These grooves may also be a source of undesirable vibrations during operation of the crusher 6. The wear is further enhanced in the case of inserts reinforced by ceramics which can be infiltrated 5, since upon its creation, the groove weakens the edges of the insert 2, the optional ceramic reinforcement 5 of which then tends to crumble and to be worn out more rapidly.

The thicker the insert 2 is, the better the wear resistance in operation will be and the thicker its optional ceramic reinforcement which can be infiltrated 5 may be. A thick ceramic reinforcement 5 will nevertheless be more difficult to infiltrate with the liquid metal during casting.

The infiltration depth depends on the available latent heat and therefore on the amount of liquid metal that is available for achieving infiltration. In the inserts of the state of the art with a low massiveness modulus, the amount of metal available for a given volume of the insert is insufficient for properly infiltrating a ceramic reinforcement beyond a thickness of about 50 mm.

The ceramic reinforcement which can be infiltrated 5 is sometimes called a wafer or further a <<padding>> or a <<cake>> and generally consists of an agglomerate of ceramic grains leaving interstices so as to let the casting metal penetrate therein. To one skilled in the art it is well known. In terms of composition, without pretending to be exhaustive, oxides such as alumina, zirconia, alumina-zirconia, silica or further metal nitrides, metal carbides such as titanium carbide or tungsten carbide, borides or mixtures of these various constituents are generally used.

The massiveness modulus of the insert is therefore directly related to the infiltration capacity of the ceramic reinforcement which can be infiltrated 5 of the insert 2 by the casting metal 4. The greater the total surface area of the insert with respect to the volume of the insert, the more the casting metal tends to cool in contact with this surface. Therefore, the higher the volume/surface ratio is, the longer the metal remains hot and the easier the infiltration of the ceramic reinforcement 5 is.

In the design of a grinding roller 1 for a vertical crusher 6 produced by foundry casting according to the state of the art, the number of inserts placed on the perimeter of the grinding roller 1 is generally determined empirically by the dimension of the insert in order to obtain sufficient mechanical strength of the operating roller (see FIG. 5).

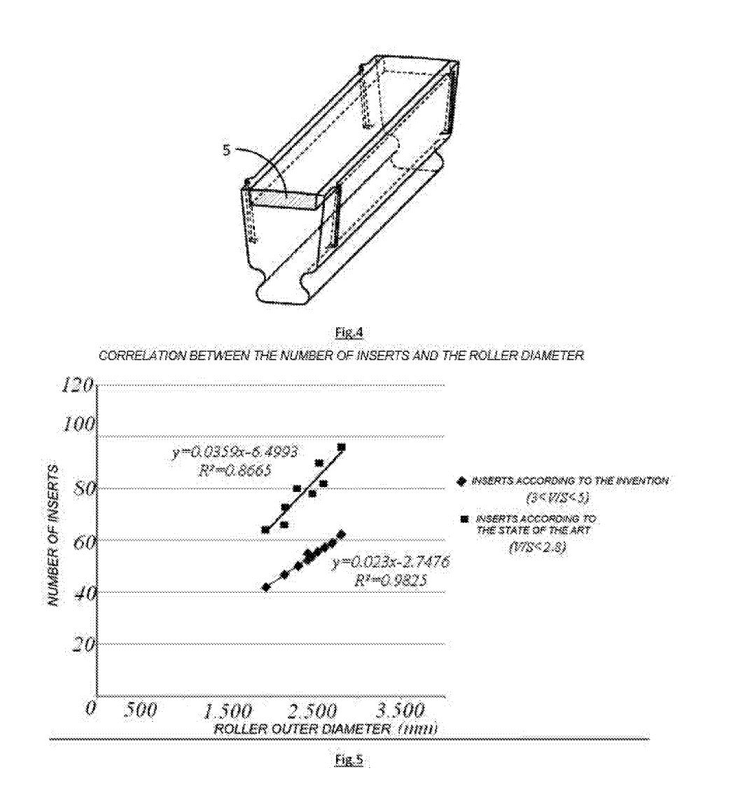

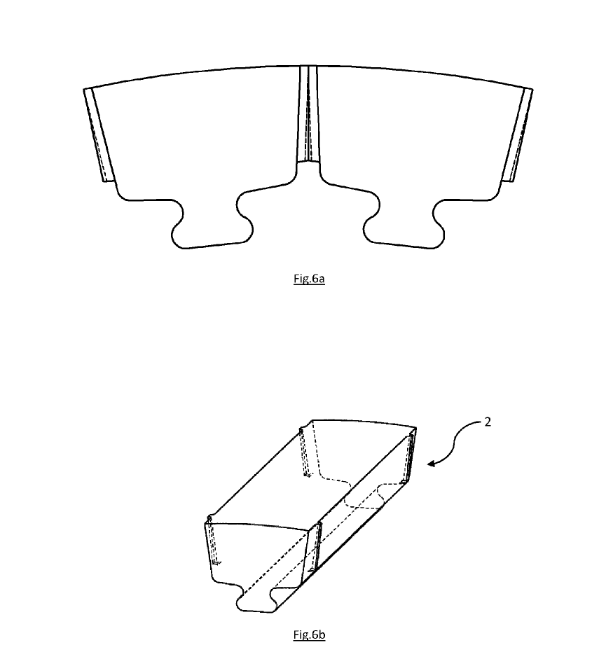

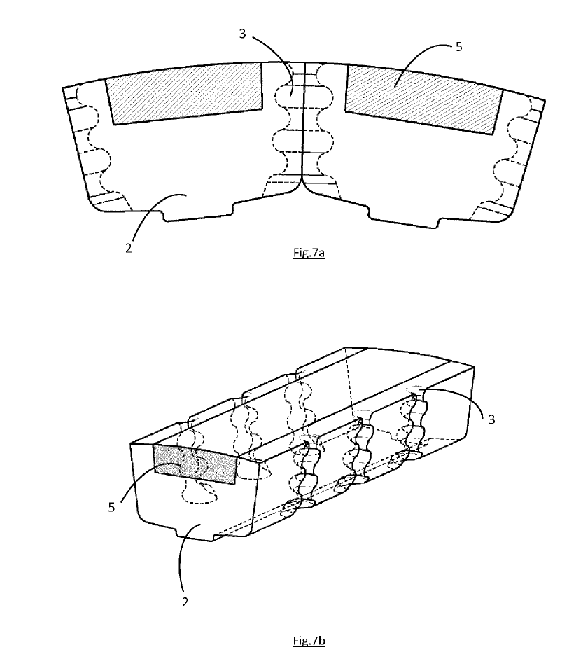

In the insert according to the state of the art, the thickness of the ceramic reinforcement 5 is set to a value of less than about 50 mm so as to guarantee good infiltration during casting. The lengths of the insert 2 and of the ceramic reinforcement 5 are approximately equal to the width of the grinding roller 1. The width of the ceramic reinforcement 5 generally corresponds to about the width of the insert (see FIG. 4).

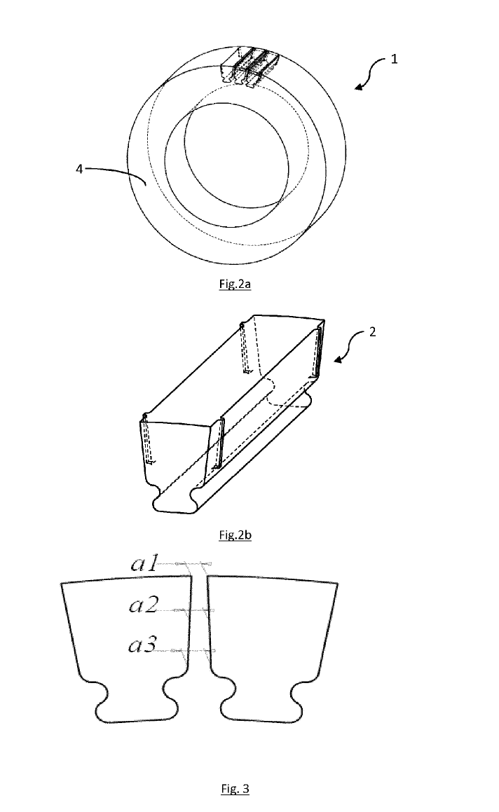

According to these requirements, the number of inserts based on the outer diameter of the roller is given by the upper curve of FIG. 5. In this design, the inserts placed in the grinding rollers have a V/S ratio comprised between 1 and 2.8 cm (see FIG. 2a).

In order to meet the objectives of the present invention, the V/S ratio of the inserts should be comprised between 3 and 5 cm, preferably between 3.2 and 4.5 cm and more preferably between 3.4 and 4 cm.

Various embodiments are possible within the scope of this invention. The figures show a series of embodiments of the invention for a roller of the same diameter and wherein the dimensions of the insert correspond to a massiveness modulus V/S between 3 and 5 cm.

FIG. 13a shows an insert 2 designed according to a preferred embodiment of the invention. It has on the lateral faces cylindrical recesses 3 where concave portions and convex portions alternate. During the casting of the metal making up the structure of the roller 1, the recesses 3 are filled with metal and the shape alternations of the recess 3 make it possible to generate binding elements of the bolt type with undercuts allowing a permanent fixation of the inserts 2 in their metal matrix 4. They secure the inserts 2 with the structure of the roller 1.

The insert 2 generally comprises a protrusion of small thickness on the lower face, thereby suppressing the risk of sliding in the radial direction of the roller 1. This protrusion of small thickness may among others appear as a dovetail ensuring the anchoring, as notably illustrated in FIG. 11b.

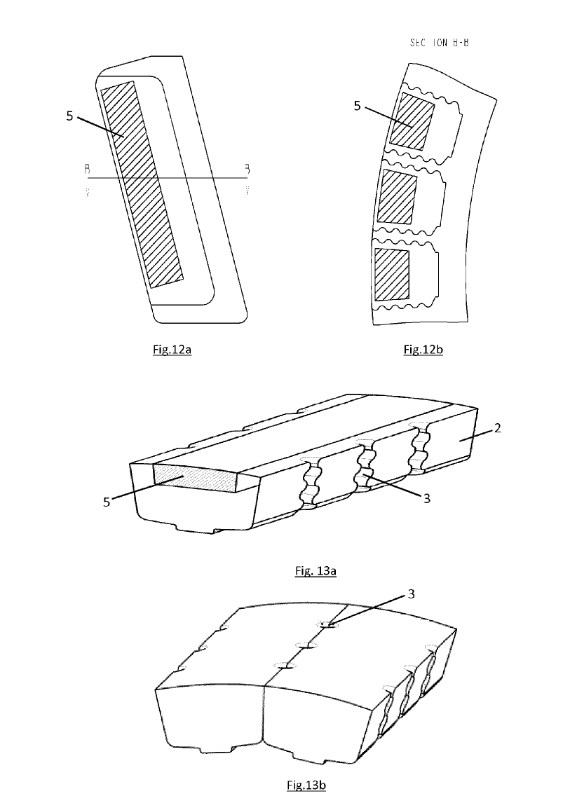

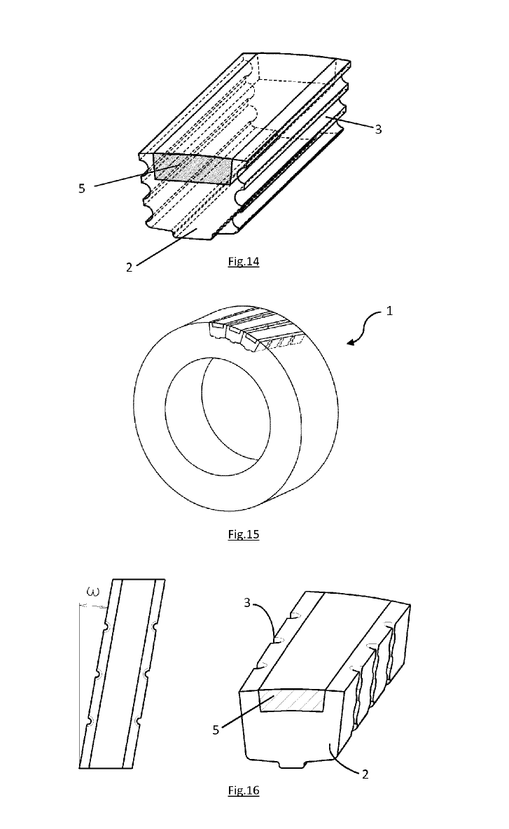

FIGS. 11 and 12 illustrate solutions which differ from each other by the contemplated thickness of the ceramic reinforcement 5, considering the significance of the stresses encountered during operation.

The embodiment of the invention according to FIGS. 13a and 13b is used when it is necessary to increase the thickness of the ceramic reinforcement 5 in the insert 2 beyond 50 mm in order to obtain increased wear resistance, but it also gives the possibility of benefiting from all the advantages mentioned above. It is particularly suitable for rollers of large diameter.

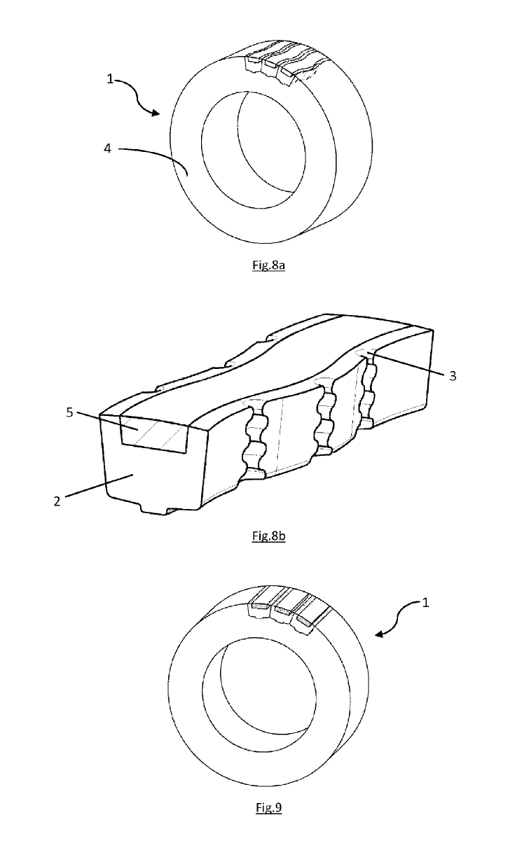

Certain undulated forms of the inserts, <<S-shaped >> forms for example, illustrated in FIGS. 8a and 8b, generate grooves of the same shape between the inserts during wear and give the possibility of mitigating the shock generated by this groove by means of the gradual encounter of the latter with the bed of material to be ground. This reduces the risk of vibrations. The examples of shapes given in the present description are non-limiting; other geometrical shapes may of course be contemplated and are part of the present invention.

### EXAMPLES

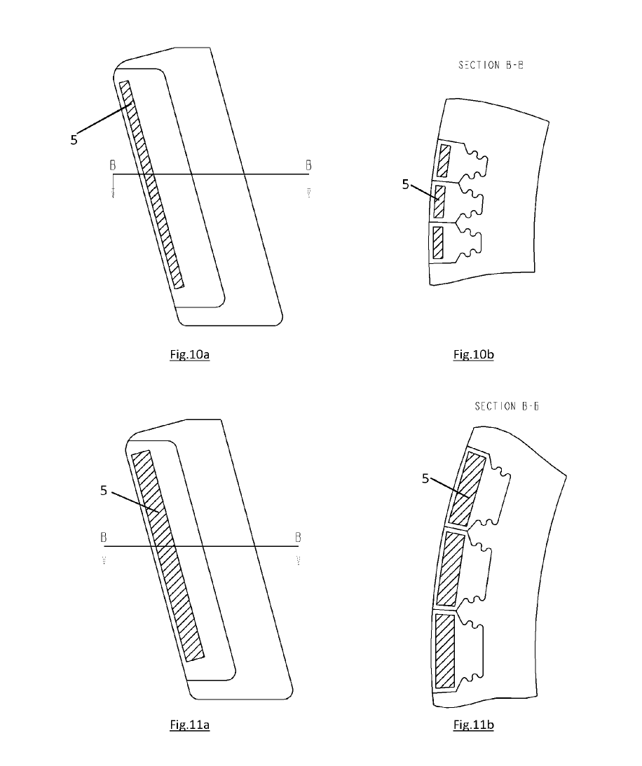

Three grinding rollers comprising three types of different inserts were experimentally tested on an LM46/4 Loesche crusher. The three types of inserts 2 are illustrated in FIGS. 10, 11 and 12. The inserts are cast in cast iron of the type with 3% by weight of carbon and 16% by weight of chromium (U19) in order to be then integrated (embedded) in a grinding roller, the metal matrix of which consists of cast iron with spheroidal graphite of the GGG40 type. The ground material is cement raw meal. The inserts 2 comprise ceramic reinforcements which can be infiltrated 5 of the alumina-zirconia type. The diameter of the rollers is 2,000 mm in the 3 cases. The number of operating hours represents the lifetime of the rollers.

The results of the tests are given in Table 1 below.

TABLE 1

| | | | Ceramic | Number | | |
|---|---|---|---|---|---|---|
| EXAMPLES | NUMBER | V/S OF | reinforcement | of | | |
| OF | OF | INSERTS | dimensions | operating | Production | Improvement |
| INSERTS | INSERTS | (cm) | (mm) | hours | (tons) | in % |
| Comparative | 73 | 2.6 | 560 × 75 × 48 | 10,000 | 3,050,000 | Reference |
| inserts | | | | | | |
| according to | | | | | | |
| the prior art | | | | | | |
| FIGS. 10a | | | | | | |
| and b | | | | | | |
| Inserts | 47 | 3.3 | 560 × 130 × 60 | 12,000 | 3,700,000 | +20% |
| according to | | | | | | |
| the invention | | | | | | |
| FIGS. 11a | | | | | | |
| and b | | | | | | |
| Inserts | 47 | 3.5 | 560 × 130 × 90 | 15,000 | 4,575,000 | +50% |
| according to | | | | | | |
| the invention | | | | | | |
| FIGS. 12a | | | | | | |
| and b | | | | | | |

1. A grinding roller for vertical axis crushers, produced by foundry casting, said roller comprising inserts embedded in a metal matrix consisting of ductile cast iron or steel, characterized in that said inserts have a massiveness modulus V/S comprised between 3 and 5 cm, preferably between 3.2 and 4.5 cm.

2. The grinding roller according to claim 1, comprising inserts with a massiveness modulus V/S comprised between 3.4 and 4 cm.

3. The grinding roller according to claim 1, wherein said inserts are placed against each other, only leaving intermittent recesses between two inserts and making it possible, during casting, to generate a binding element of the bolt type improving the fixation of the insert in the metal matrix.

4. The grinding roller according to claim 3, wherein the binding element of the bolt type comprises undercuts.

5. The grinding roller according to claim 2, wherein the inserts are not placed parallel to the axis of rotation of said grinding roller, but form an angle of less than 45° with this axis.

6. The grinding roller according to claim 2, wherein the inserts have a curvature along their longitudinal axis.

7. The grinding roller according to claim 6, wherein the inserts have an “S” shape along their longitudinal axis.

8. The grinding roller according to claim 2, wherein the insert comprises one or several ceramic reinforcements) which can be infiltrated by the casting metal.

9. The grinding roller according to claim 8, wherein said reinforcement ceramic is selected from among alumina, zirconia, alumina-zirconia, metal nitrides, metal carbides and borides or mixtures thereof.

10. A vertical axis crusher comprising a grinding roller according to claim 1.
